(19) United States
(12) Patent Application Publication
(10) Pub. No.: US 2024/0396172 A1
(43) Pub. Date: Nov. 28, 2024

(54) POWER STORAGE CELL AND METHOD FOR MANUFACTURING THE SAME

(71) Applicant: TOYOTA JIDOSHA KABUSHIKI KAISHA, Toyota-shi (JP)

(72) Inventors: Takeshi ABE, Okazaki-shi (JP); Ryuta SUGIURA, Toyota-shi (JP); Tomoyuki UEZONO, Okazaki-shi (JP); Takenori IKEDA, Owariasahi-shi (JP); Yuki TAKAHASHI, Miyoshi-shi (JP); Kenta KIMURA, Toyota-shi (JP)

(73) Assignee: TOYOTA JIDOSHA KABUSHIKI KAISHA, Toyota-shi (JP)

(21) Appl. No.: 18/633,070

(22) Filed: Apr. 11, 2024

(30) Foreign Application Priority Data
May 25, 2023 (JP) 2023-086386

(51) Int. Cl. H01M 50/46; H01M 10/04; H01M 50/107

(52) U.S. Cl. CPC H01M 50/461; H01M 10/0431; H01M 50/107

(57) ABSTRACT

A power storage cell includes an electrode assembly constructed as a wound body in which a positive electrode sheet and a negative electrode sheet are wound with a separator interposed therebetween. The separator includes a separator layer, and an adhesion layer provided on at least one of an inner surface and an outer surface of the separator layer in a radial direction of the electrode assembly. A termination end portion of the electrode assembly is affixed via the adhesion layer to a portion included in the electrode assembly and positioned inside the termination end portion in the radial direction.

### CROSS REFERENCE TO RELATED APPLICATIONS

This nonprovisional application is based on Japanese Patent Application No. 2023-086386 filed on May 25, 2023 with the Japan Patent Office, the entire contents of which are hereby incorporated by reference.

### BACKGROUND

### Field

The present disclosure relates to a power storage cell and a method for manufacturing the same.

### Description of the Background Art

Japanese Patent Laying-Open No. 2010-212086 discloses a nonaqueous electrolyte secondary battery that includes a wound electrode assembly where a positive electrode plate and a negative electrode plate are wound with a separator interposed therebetween while being insulated from each other, and a battery outer can housing the wound electrode assembly. In the wound electrode assembly, the separator is arranged on the outermost periphery and fixed on the outermost periphery of the wound electrode assembly using an adhesive tape for fixing a winding end.

### SUMMARY

In such a power storage cell including a wound electrode assembly, which is described in Japanese Patent Laying-Open No. 2010-212086 for example, the diameter of a portion of the electrode assembly to which an adhesive tape for fixing a winding end adheres is larger than the diameter of the remaining portion. Accordingly, relatively large stress occurs on the portion to which the adhesive tape adheres when the electrode assembly expands.

An object of the present disclosure is to provide a power storage cell and a method for manufacturing the same that can inhibit nonuniform distribution of the stress caused on an electrode assembly when the electrode assembly expands.

A power storage cell according to an aspect of the present disclosure includes an electrode assembly that includes a positive electrode sheet, a negative electrode sheet, and a separator, and is constructed as a wound body in which the positive electrode sheet and the negative electrode sheet are wound with the separator interposed therebetween. The separator includes a separator layer, and an adhesion layer provided on at least one of an inner surface and an outer surface of the separator layer in a radial direction of the electrode assembly. A termination end portion of the electrode assembly is affixed via the adhesion layer to a portion included in the electrode assembly and positioned inside the termination end portion in the radial direction.

A method for manufacturing a power storage cell according to an aspect of the present disclosure includes a winding step of winding a positive electrode sheet and a negative electrode sheet with a separator interposed therebetween to form an electrode assembly constructed as a wound body; and a termination-end-portion fixing step of fixing a termination end portion of the electrode assembly. The separator used in the winding step includes a separator layer, and an adhesion layer provided on at least one of an inner surface and an outer surface of the separator layer in a radial direction of the electrode assembly, and in the termination-end-portion fixing step, the termination end portion is affixed via the adhesion layer to a portion included in the electrode assembly and positioned inside the termination end portion.

The foregoing and other objects, features, aspects, and advantages of the present disclosure will become apparent from the following detailed description on the present disclosure, which will be understood with reference to the accompanying drawings.

### BRIEF DESCRIPTION OF THE DRAWINGS

FIG. 1 is a cross-sectional view that schematically illustrates a power storage cell according to an embodiment of the present disclosure.

FIG. 2 is a front view that schematically illustrates an electrode assembly.

FIG. 3 is a cross-sectional view that schematically illustrates the vicinity of an extension portion of a separator.

FIG. 4 is a cross-sectional view that schematically illustrates a variation of the electrode assembly.

FIG. 5 is a cross-sectional view that schematically illustrates a variation of the electrode assembly.

FIG. 6 is a cross-sectional view that schematically illustrates a variation of the electrode assembly.

### DESCRIPTION OF THE PREFERRED EMBODIMENTS

Embodiments of the present disclosure are described with reference to the drawings. In the drawings referred to below, the same reference numerals are given to identical or equivalent members.

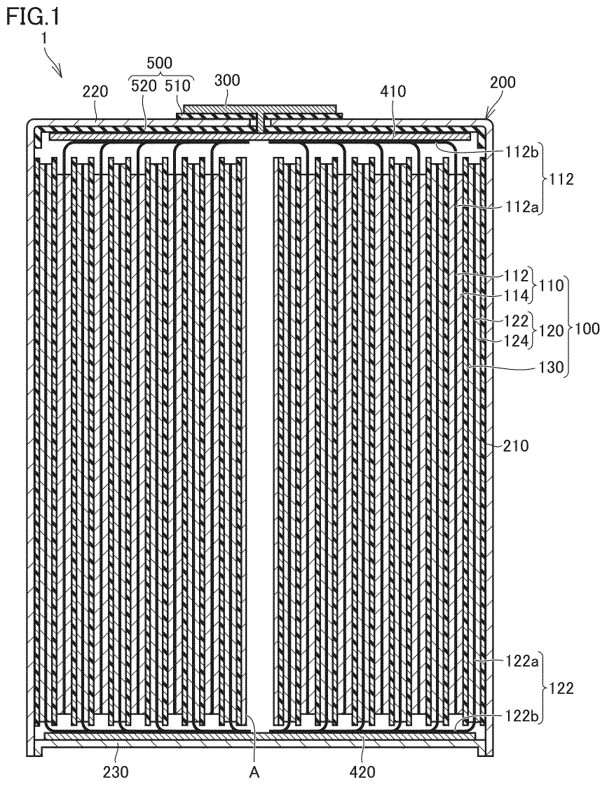

FIG. 1 is a partial cross-sectional view that schematically illustrates a power storage cell 1 according to an embodiment of the present disclosure. Power storage cell 1 is preferably mounted on a vehicle.

As illustrated in FIG. 1, power storage cell 1 includes an electrode assembly 100, a cell case 200, an external terminal 300, a positive electrode current collector plate 410, a negative electrode current collector plate 420, an insulation member 500, and an electrolyte solution (not illustrated).

Electrode assembly 100 includes a positive electrode sheet 110, a negative electrode sheet 120, and a separator 130. Electrode assembly 100 is constructed as a wound body in which positive electrode sheet 110 and negative electrode sheet 120 are wound around a winding core A with separator 130 interposed therebetween.

As illustrated in FIG. 1, positive electrode sheet 110 includes a positive electrode current collector foil 112 and a positive electrode active material layer 114.

Positive electrode current collector foil 112 is made of metal such as aluminum. Positive electrode current collector foil 112 includes a main region 112a and an end region 112b.

Main region 112a is a region of positive electrode current collector foil 112, where positive electrode active material layer 114 is provided. As illustrated in FIG. 1, main region 112a is arranged so as to overlap each other in a radial direction of electrode assembly 100 (the lateral direction in FIG. 1).

End region 112b is a region of positive electrode current collector foil 112, where positive electrode active material layer 114 is not provided. As illustrated in FIG. 1, end region 112b lies outside main region 112a (i.e., lies on the upper side in FIG. 1) in an axial direction of electrode assembly 100 (the longitudinal direction in FIG. 1).

End region 112b includes a plurality of tabs, which are separate from each other in a circumferential direction of electrode assembly 100. Each tab falls down inward in the radial direction. The upper surface of each tab forms an approximately flat surface. Positive electrode current collector plate 410 is connected to each tab by welding or the like.

Negative electrode sheet 120 includes a negative electrode current collector foil 122, which is made of metal such as copper, and a negative electrode active material layer 124, which is provided on a surface of negative electrode current collector foil 122.

The structure of negative electrode current collector foil 122 is substantially the same as the structure of positive electrode current collector foil 112. Thus, description on negative electrode current collector foil 122 is simplified. That is, negative electrode current collector foil 122 includes a main region 122a, where negative electrode active material layer 124 is provided, and an end region 122b, which lies outside main region 122a (i.e., lies on the lower side in FIG. 1) in the axial direction. End region 122b includes a plurality of tabs separate from each other in the circumferential direction, and each tab falls down inward in the radial direction. Negative electrode current collector plate 420 is connected to each tab by welding or the like.

Separator 130 is arranged between positive electrode sheet 110 and negative electrode sheet 120. More specifically, separator 130 is arranged only between main region 112a of positive electrode sheet 110 and main region 122a of negative electrode sheet 120, which are adjacent to each other in the radial direction. Separator 130 is made from an insulation material and allows ions to pass therethrough.

As illustrated in FIG. 3, separator 130 includes a separator layer 132 and an adhesion layer 134.

Adhesion layer 134 is provided on at least one of the inner surface and the outer surface of separator layer 132 in the radial direction. In the example illustrated in FIG. 3, adhesion layer 134 is provided only on the inner surface of separator layer 132 in the radial direction. However, adhesion layer 134 may be provided only on the outer surface of separator layer 132 in the radial direction. Adhesion layer 134 makes the adhesion state of electrode sheets 110 and 120 to separator layer 132 favorable.

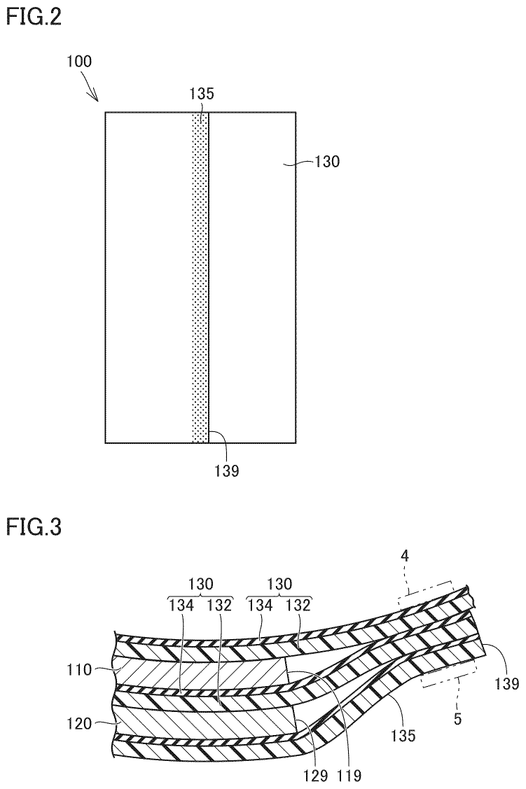

As illustrated in FIGS. 2 and 3, separator 130 includes an extension portion 135. In FIG. 2, the dot pattern denotes extension portion 135. Extension portion 135 extends further than a termination end 119 of positive electrode sheet 110 and a termination end 129 of negative electrode sheet 120 in the circumferential direction. Extension portion 135 is affixed via adhesion layer 134 to separator 130 positioned inside extension portion 135 in the radial direction. As illustrated in FIG. 3, extension portion 135 is affixed (welded) by getting heated with the assistance of jigs 4 and 5. After the affixation of extension portion 135, jig 4 is pulled out of electrode assembly 100 in the axial direction.

Cell case 200 houses electrode assembly 100. In cell case 200, the unillustrated electrolyte solution is housed. Cell case 200 is hermetically sealed. Cell case 200 is made of metal such as aluminum. Cell case 200 includes a cylindrical portion 210, a top wall 220, and a bottom wall 230.

Cylindrical portion 210 surrounds the outer circumferential surface of electrode assembly 100.

Top wall 220 is connected to an upper end portion of cylindrical portion 210. In a central portion of top wall 220, a through hole is formed, in which the external terminal 300 is inserted.

Bottom wall 230 is connected by welding or the like to a lower end portion of cylindrical portion 210. Bottom wall 230 is in contact with negative electrode current collector plate 420.

External terminal 300 is arranged over top wall 220. In the present embodiment, external terminal 300 forms a positive electrode external terminal. Cell case 200 forms a negative electrode external terminal.

Insulation member 500 insulates cell case 200 and external terminal 300 from each other. Insulation member 500 includes an upper insulation portion 510 and a lower insulation portion 520.

Upper insulation portion 510 is arranged on the upper surface of top wall 220. Upper insulation portion 510 is interposed between the upper surface of top wall 220 and external terminal 300.

Lower insulation portion 520 is arranged on the lower surface of top wall 220. Lower insulation portion 520 is interposed between positive electrode current collector plate 410 and cell case 200.

A method for manufacturing power storage cell 1 is described below. This manufacturing method includes a winding step and a termination-end-portion fixing step.

In the winding step, positive electrode sheet 110 and negative electrode sheet 120 are wound with separator 130 interposed therebetween to form electrode assembly 100 constructed as a wound body.

In the termination-end-portion fixing step, a termination end portion of electrode assembly 100 is fixed. In the termination-end-portion fixing step, the termination end portion is affixed via adhesion layer 134 to a portion included in electrode assembly 100 and positioned inside the termination end portion. In the present embodiment, extension portion 135 forms the termination end portion.

As described above, in power storage cell 1 in the present embodiment, a termination end portion of electrode assembly 100 is fixed using adhesion layer 134 of separator 130. Accordingly, a tape or the like for fixing electrode assembly 100 can be dispensed with. As a result, nonuniform distribution of the stress caused on electrode assembly 100 when electrode assembly 100 expands is inhibited.

Although the above-described embodiment exhibits an example in which adhesion layer 134 is provided entirely on separator layer 132, adhesion layer 134 may be provided only on extension portion 135 or be provided only on a portion included in separator 130 that forms the outermost periphery of electrode assembly 100 and extending between a termination end 139 of separator 130 and a position located away from termination end 139 by approximately a quarter of the total circumferential length of separator 130 that forms the outermost periphery.

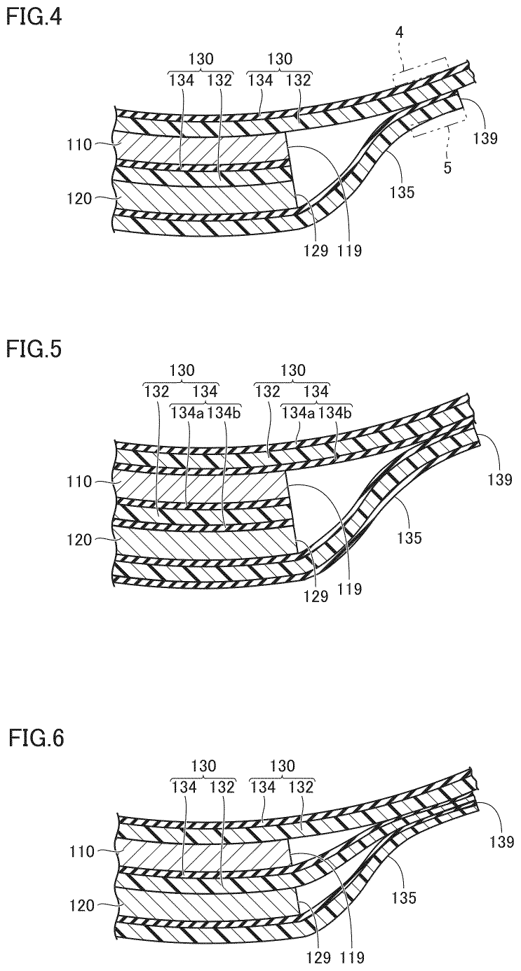

As illustrated in FIG. 4, only separator 130 arranged on the outermost periphery of electrode assembly 100 may include extension portion 135.

As illustrated in FIG. 5, adhesion layer 134 of separator 130 may include an inner adhesion element 134a, which is provided on the inner surface of separator layer 132 in the radial direction, and an outer adhesion element 134b, which is provided on the outer surface of separator layer 132 in the radial direction. Although FIG. 5 illustrates an example in which only separator 130 arranged on the outermost periphery of electrode assembly 100 includes extension portion 135, the configuration of adhesion layer 134 including inner adhesion element 134a and outer adhesion element 134b is also applicable to a case where both two separators 130 include respective extension portions 135 as in the above-described embodiment.

As illustrated in FIG. 6, extension portion 135 may gradually decrease in thickness with increase in distance from termination end 119 of positive electrode sheet 110 and termination end 129 of negative electrode sheet 120. For example, this shape can be obtained by, in the winding step, making the tension applied onto extension portion 135 larger than the tension applied onto positive electrode sheet 110, negative electrode sheet 120, and separator 130 when portions included in electrode assembly 100 and extending to termination end 119 of positive electrode sheet 110 and termination end 129 of negative electrode sheet 120 are wound.

In addition, although the above-described embodiment presents an example in which separator 130 is arranged on the outermost periphery of electrode assembly 100, an electrode sheet (such as negative electrode sheet 120) may be arranged on the outermost periphery of electrode assembly 100.

Those skilled in the art will understand that the above-described exemplary embodiments are specific examples of the following aspects.

### [Aspect 1]

A power storage cell comprising
an electrode assembly that includes a positive electrode sheet, a negative electrode sheet, and a separator, and is constructed as a wound body in which the positive electrode sheet and the negative electrode sheet are wound with the separator interposed therebetween,
the separator including
   a separator layer, and
   an adhesion layer provided on at least one of an inner surface and an outer surface of the separator layer in a radial direction of the electrode assembly, wherein
a termination end portion of the electrode assembly is affixed via the adhesion layer to a portion included in the electrode assembly and positioned inside the termination end portion in the radial direction.

In the power storage cell, a termination end portion of the electrode assembly is fixed using the adhesion layer of the separator. Accordingly, a tape or the like for fixing the electrode assembly can be dispensed with. As a result, nonuniform distribution of the stress caused on the electrode assembly when the electrode assembly expands is inhibited.

### [Aspect 2]

The power storage cell according to aspect 1, wherein
the separator includes an extension portion that extends further than a termination end of the positive electrode sheet and a termination end of the negative electrode sheet in a circumferential direction of the electrode assembly, and
the extension portion is affixed via the adhesion layer to the separator positioned inside the extension portion in the radial direction.

### [Aspect 3]

The power storage cell according to aspect 2, wherein the extension portion gradually decreases in thickness with increase in distance from the termination end of the positive electrode sheet and the termination end of the negative electrode sheet.

According to this aspect, the roundness of the electrode assembly is enhanced. As a result, nonuniform distribution of the stress caused on the electrode assembly when the electrode assembly expands is inhibited with higher reliability.

### [Aspect 4]

The power storage cell according to any one of aspects 1 to 3, wherein the adhesion layer includes
an inner adhesion element provided on the inner surface of the separator layer in the radial direction, and
an outer adhesion element provided on the outer surface of the separator layer in the radial direction.

### [Aspect 5]

A method for manufacturing a power storage cell, the method comprising:
a winding step of winding a positive electrode sheet and a negative electrode sheet with a separator interposed therebetween to form an electrode assembly constructed as a wound body; and
a termination-end-portion fixing step of fixing a termination end portion of the electrode assembly, wherein
the separator used in the winding step includes a separator layer, and an adhesion layer provided on at least one of an inner surface and an outer surface of the separator layer in a radial direction of the electrode assembly, and
in the termination-end-portion fixing step, the termination end portion is affixed via the adhesion layer to a portion included in the electrode assembly and positioned inside the termination end portion.

### [Aspect 6]

The method for manufacturing a power storage cell according to aspect 5, wherein
the separator used in the winding step includes an extension portion that extends further than a termination end of the positive electrode sheet and a termination end of the negative electrode sheet in a circumferential direction of the electrode assembly, and
in the winding step, tension applied onto the extension portion is made larger than tension applied onto the positive electrode sheet, the negative electrode sheet, and the separator when portions included in the electrode assembly and extending to the termination end of the positive electrode sheet and the termination end of the negative electrode sheet are wound.

According to this aspect, the extension portion gradually decreases in thickness with increase in distance from the termination end of the positive electrode sheet and the termination end of the negative electrode sheet, and the roundness of the electrode assembly is enhanced accordingly. As a result, nonuniform distribution of the stress caused on the electrode assembly when the electrode assembly expands is inhibited with higher reliability.

Although embodiments of the present disclosure have been described, it should be understood that the herein-disclosed embodiments are presented by way of illustration and example in every respect and are not to be taken by way of limitation. The scope of the present disclosure is defined by the claims and intended to include all changes within the purport and scope equivalent to the claims.

What is claimed is:

1. A power storage cell comprising
an electrode assembly that includes a positive electrode sheet, a negative electrode sheet, and a separator, and is constructed as a wound body in which the positive electrode sheet and the negative electrode sheet are wound with the separator interposed therebetween,
the separator including
a separator layer, and
an adhesion layer provided on at least one of an inner surface and an outer surface of the separator layer in a radial direction of the electrode assembly, wherein
a termination end portion of the electrode assembly is affixed via the adhesion layer to a portion included in the electrode assembly and positioned inside the termination end portion in the radial direction.

2. The power storage cell according to claim 1, wherein
the separator includes an extension portion that extends further than a termination end of the positive electrode sheet and a termination end of the negative electrode sheet in a circumferential direction of the electrode assembly, and
the extension portion is affixed via the adhesion layer to the separator positioned inside the extension portion in the radial direction.

3. The power storage cell according to claim 2, wherein the extension portion gradually decreases in thickness with increase in distance from the termination end of the positive electrode sheet and the termination end of the negative electrode sheet.

4. The power storage cell according to claim 1, wherein the adhesion layer includes
an inner adhesion element provided on the inner surface of the separator layer in the radial direction, and
an outer adhesion element provided on the outer surface of the separator layer in the radial direction.

5. A method for manufacturing a power storage cell, the method comprising:
a winding step of winding a positive electrode sheet and a negative electrode sheet with a separator interposed therebetween to form an electrode assembly constructed as a wound body; and
a termination-end-portion fixing step of fixing a termination end portion of the electrode assembly, wherein
the separator used in the winding step includes a separator layer, and an adhesion layer provided on at least one of an inner surface and an outer surface of the separator layer in a radial direction of the electrode assembly, and
in the termination-end-portion fixing step, the termination end portion is affixed via the adhesion layer to a portion included in the electrode assembly and positioned inside the termination end portion.

6. The method for manufacturing a power storage cell according to claim 5, wherein
the separator used in the winding step includes an extension portion that extends further than a termination end of the positive electrode sheet and a termination end of the negative electrode sheet in a circumferential direction of the electrode assembly, and
in the winding step, tension applied onto the extension portion is made larger than tension applied onto the positive electrode sheet, the negative electrode sheet, and the separator when portions included in the electrode assembly and extending to the termination end of the positive electrode sheet and the termination end of the negative electrode sheet are wound.
